(19) United States
(12) Patent Application Publication
(10) Pub. No.: US 2014/0281632 A1
(43) Pub. Date: Sep. 18, 2014

(54) ELECTRONIC APPARATUS THAT MEASURES POWER DURING POWER SAVING STATE, METHOD OF CONTROLLING THE SAME, AND STORAGE MEDIUM

(71) Applicant: CANON KABUSHIKI KAISHA, Tokyo (JP)

(72) Inventor: Keisuke KITAJIMA, Kawasaki-shi (JP)

(73) Assignee: CANON KABUSHIKI KAISHA, Tokyo (JP)

(21) Appl. No.: 14/206,405

(22) Filed: Mar. 12, 2014

(30) Foreign Application Priority Data
Mar. 12, 2013 (JP) 2013-049237

(51) Int. Cl. G06F 1/32

(52) U.S. Cl. CPC G06F 1/3203
USPC 713/323

(57) ABSTRACT

An electronic apparatus capable of accurately measuring an amount of electric power consumed during a power saving state while reducing an amount of electric power necessary for electric power measurement in the power saving state to a minimum. The apparatus is equipped with a power saving function for switching an operation mode between a normal state and a power saving state. A power measurement section measures a power of the image forming apparatus. A controller manages the power of apparatus based on the power measured by the power measurement section. When it is determined that the operation mode is the power saving state, the power measurement section stores the measured power without sending the same to the controller.

### BACKGROUND OF THE INVENTION

1. Field of the Invention

The present invention relates to an electronic apparatus including a power measurement unit, a method of controlling the same, and a storage medium.

2. Description of the Related Art

For electronic apparatuses, such as printer and multifunction peripherals, there is a demand that the amount of used electric power be reduced, and to meet this demand, there has been proposed an electronic apparatus equipped with a power saving function for shifting the apparatus to a power saving state (power saving mode) when in standby. Further, with increased awareness of environmental problems in recent years, there has been proposed an electronic apparatus equipped with a power meter which enables a user to grasp the amount of electric power consumed by the electronic apparatus. For example, there has been disclosed a technique for calculating a total amount of power consumption of an electronic apparatus by stopping supply of power to a power measurement section during the power saving state and using an estimated amount of electric power stored in the apparatus in advance (see Japanese Patent Laid-Open Publication No. 2012-56153).

However, in such a system that calculates the total amount of power consumption based on the estimated amount of electric power stored in the apparatus in advance, factors of apparatus variation and installation environment (e.g. quality of commercial power supply and ambient temperature) are not taken into account. Therefore, there is a problem that a difference is generated between the displayed amount of power consumption and the actual amount of power consumption. Further, under such a condition that the power saving state continues for a long time, there is a fear that the above-mentioned difference further increases.

### SUMMARY OF THE INVENTION

The present invention provides an electronic apparatus that is capable of accurately measuring an amount of electric power consumed during a power saving state while reducing an amount of electric power necessary for electric power measurement in the power saving state to a minimum, a method of controlling the same, and a storage medium.

In a first aspect of the present invention, there is provided an electronic apparatus equipped with a power saving function for switching an operation mode between a normal state and a power saving state, comprising a measurement unit configured to measure a power of the electronic apparatus, and a management unit configured to manage the power of the electronic apparatus based on the power measured by the measurement unit, wherein when it is determined that the operation mode is the power saving state, the measurement unit stores the measured power without sending the measured power to the management unit.

In a second aspect of the present invention, there is provided a method of controlling an electronic apparatus equipped with a power saving function for switching an operation mode between a normal state and a power saving state, comprising measuring a power of the electronic apparatus, managing the power of the electronic apparatus based on the power measured by the measuring, and storing, when it is determined that the operation mode is the power saving state, the measured power without sending the measured power to the management unit.

In a third aspect of the present invention, there is provided non-transitory computer-readable storage medium storing a computer-executable program for executing a method of controlling an electronic apparatus equipped with a power saving function for switching an operation mode between a normal state and a power saving state, wherein the method comprises measuring a power of the electronic apparatus, managing the power of the electronic apparatus based on the power measured by the measuring, and storing, when it is determined that the operation mode is the power saving state, the measured power without sending the measured power to the management unit.

According to the present invention, it is possible to accurately measure the amount of electric power consumed during the power saving state while reducing the amount of electric power necessary for electric power measurement during the power saving state to a minimum.

Further features of the present invention will become apparent from the following description of exemplary embodiments with reference to the attached drawings.

### BRIEF DESCRIPTION OF THE DRAWINGS

FIG. 1 is a schematic block diagram of an image forming apparatus which is an example of an electronic apparatus according to a first embodiment of the present invention.

FIG. 2 is a schematic diagram showing the configuration of a controller appearing in FIG. 1 including electrical connections.

FIG. 3 is a schematic diagram showing the configuration of a power measurement section appearing in FIG. 1 including electrical connections.

FIG. 4 is a power supply system diagram showing a plurality of power supply systems in a power supply section, and the outline of loads connected to each power supply system.

FIG. 5 is a flowchart of a power consumption measurement process executed by the power measurement section.

FIG. 6 is a flowchart of a power consumption measurement result-receiving process executed by the controller.

FIG. 7 is a diagram showing an example of a power consumption display screen displayed on a console section.

FIG. 8 is a flowchart of an operation mode-shifting process executed when the image forming apparatus shifts to the power saving state and when the image forming apparatus returns from the power saving state.

FIG. 9A is a flowchart of a power consumption measurement process executed by a power measurement section of an image forming apparatus according to a second embodiment of the present invention.

FIG. 9B is a continuation of FIG. 9A.

FIG. 10 is a flowchart of an operation mode-shifting process executed when the image forming apparatus shifts to the power saving state and when the image forming apparatus returns from the power saving state.

FIG. 11 is a flowchart of a process executed by the power measurement section for responding to an average power consumption amount acquisition request received from the controller in a step in FIG. 10.

### DESCRIPTION OF THE EMBODIMENTS

The present invention will now be described in detail below with reference to the accompanying drawings showing embodiments thereof.

FIG. 1 is a schematic block diagram of an image forming apparatus which is an example of an electronic apparatus according to a first embodiment of the present invention.

Referring to FIG. 1, the image forming apparatus, denoted by reference numeral 100, is equipped with a power saving function for switching an operation mode between a normal state (normal mode) and a power saving state (power saving mode), and includes a power supply section 10, a controller 20, a printer section 30, a scanner section 40, a console section 50, a power measurement section 60, and a main power switch 80.

The power supply section 10 is connected to a commercial power supply 70 via the power measurement section 60 and the main power switch 80. The power supply section 10 is further connected to the controller 20, the printer section 30, the scanner section 40, and the console section 50, and generates electric power necessary for each of the sections based on electric power supplied from the commercial power supply 70. Further, the power supply section 10 is configured to be capable of switching on and off of the power supply to each section according to a power supply control instruction from the controller 20.

The printer section 30 causes laser beams to be illuminated and emitted according to image signals for C (cyan), Y (yellow), M (magenta), and K (black) colors received from the controller 20, and irradiates photosensitive drums (not shown) charged by four electrostatic charger (not shown) with the laser beams, respectively. By irradiating the photosensitive drums with the laser beams, electrostatic latent images are formed on the photosensitive drums according to the image signals, respectively, and toner images formed by subjecting the electrostatic latent images to development processing by respective developing devices (not shown) configured to be constantly replenished with toner are transferred and fixed onto a recording material.

The scanner section 40 is composed of LEDs and a CCD sensor (not shown) using an RGB filter, and is configured to irradiate a conveyed original with light, divide the reflected light into color components of the three colors of R (red), G (green), and B (black) by the RGB filter, and send the divided components to the controller 20 as image data.

The console section 50 is a user interface part including a liquid crystal panel for displaying the state of the image forming apparatus 100, and a touch panel and keys for enabling the user to operate the apparatus, and is connected to the controller 20.

FIG. 2 is a schematic diagram showing the configuration of the controller 20 appearing in FIG. 1 including electrical connections.

Referring to FIG. 2, a CPU 2001 is a main CPU that executes various programs, including those for control processes associated with image formation. Further, the CPU 2001 is connected to each of blocks, described hereinafter, via a system bus 2004, and transmits a signal to each block according to an executed program.

A ROM 2002 stores the various programs executed by the CPU 2001. A RAM 2003 is used as a work area and an area for temporarily storing image data, when the CPU 2001 executes the various programs.

An NVRAM 2008 is a nonvolatile memory, and is used for storing various setting information in the controller 20 during the powered-off state of the apparatus. A hard disk drive (HDD) 2009 stores various programs for causing the image forming apparatus 100 to operate, image data, and so forth.

A console section interface 2005 is an interface connected to the console section 50. A scanner controller 2006 transfers image data received from the scanner section 40 to the RAM 2003. A printer controller 2007 sends an image signal to the printer section 30.

A communication controller 2010 is connected to a network 2011 to communicate with an apparatus (not shown) which is a host terminal.

A power supply controller 2012 is connected to the power supply section 10 to control on/off of power supply to each of the sections. A power measurement section interface 2013 transfers data received from the power measurement section 60 to the CPU 2001. The power measurement section 60 is further connected to the power supply controller 2012, and the power supply controller 2012 is configured to be capable of controlling power supply to the power measurement section 60 according to the data received from the power measurement section 60.

A RTC (real time clock) 2014 is a unit for counting time, and is capable of always operating by an internal battery (not shown) even in a state where power supply to the apparatus is stopped.

FIG. 3 is a schematic diagram showing the configuration of the power measurement section 60 appearing in FIG. 1 including electrical connections.

Referring to FIG. 3, a CPU 6001 calculates a power consumption amount of the image forming apparatus 100 based on a value of electric current detected by a current detecting section 6007 and a value of voltage detected by a voltage detecting section 6008. Further, the CPU 6001 periodically calculates the power consumption amount using a timer 6005, and notifies the controller 20 of the calculation result via a communication interface 6003.

The CPU 6001 reads and executes a program stored in a ROM 6006 when started up. Further, the CPU 6001 executes various programs using a RAM 6002 as a work area. Further, the CPU 6001 stores data required to be held even after power supply is stopped, in an NVRAM 6004. The blocks forming the power measurement section 60 are connected to each other via a system bus 6009.

The current detecting section 6007 is configured to detect an amount of electric current flowing through a live line (L) of the commercial power supply 70 as a magnetic flux, then convert the magnetic flux to voltage, further convert the detected value of voltage from analog to digital, and notifies the CPU 6001 of the digital value as the amount of current. The voltage detecting section 6008 converts a value of voltage obtained by dividing voltage between the live line (L) and the neutral line (N) of the commercial power supply 70 from analog to digital, and notifies the CPU 6001 of the digital value as the value of voltage.

FIG. 4 is a power supply system diagram showing a plurality of power supply systems in the power supply section 10, and the outline of loads connected to each power supply system.

The power supply section 10 supplies power from the commercial power supply 70 through three routes of a power supply system A 1001, a power supply system B 1002, and a power supply system C 1003.

The power supply system A 1001 is always active when the main power switch 80 is on, and supplies power to the RAM 2003, the communication controller 2010, and the power supply controller 2012 of the controller 20.

The power supply system B 1002 is a power source for supplying power to the power measurement section 60, and is capable of switching on and off of the power supply to the power measurement section 60 under the control of the power supply controller 2012.

The power supply system C 1003 supplies power to the printer section 30, the scanner section 40, the console section 50, and the rest of sections of the controller 20, to which power is not supplied by the power supply system A. Further, the power supply system C 1003 is controlled by the power supply controller 2012, and is configured to stop power supply, when the image forming apparatus 100 has shifted to the power saving state, so as to reduce the power consumption of the apparatus.

FIG. 5 is a flowchart of a power consumption measurement process executed by the power measurement section 60 according to the first embodiment. The present process is executed by the CPU 6001 of the power measurement section 60.

The power measurement section 60 is configured to periodically send a calculated power consumption amount to the controller 20 as mentioned above. To this end, the CPU 6001 determines whether or not a predetermined time period has elapsed (step S101). The timer 6005 is used for determining whether or not the predetermined time period has elapsed. If it is determined that the predetermined time period has elapsed, the CPU 6001 calculates a power consumption amount (step S102). More specifically, the CPU 6001 calculates a power consumption amount P using the following equation based on a value of current and a value of voltage detected respectively by the current detecting section 6007 and the voltage detecting section 6008:

P=V*I*cos Θ*t

wherein V: value of voltage, I: value of current, Θ: power factor, t: predetermined time period (fixed time)

Next, the CPU 6001 determines whether or not the image forming apparatus 100 is in the power saving state (power saving mode) (step S103). More specifically, the CPU 6001 communicates with the controller 20 via the communication interface 6003, and if a response is received from the controller 20, it is determined that the image forming apparatus 100 is in the normal state, whereas if not, it is determined that image forming apparatus 100 is in the power saving state. If it is determined in the step S103 that the image forming apparatus 100 is not in the power saving state, the CPU 6001 proceeds to a step S104, whereas if it is determined that image forming apparatus 100 is in the power saving state, the CPU 6001 proceeds to a step S109.

In the step S104, the CPU 6001 determines whether or not an integral power consumption has been stored in the NVRAM 6004. If it is determined in the step S104 that an integral power consumption has been stored, the CPU 6001 proceeds to a step S105, whereas if not, the CPU 601 proceeds to a step S108.

In the step S105, the CPU 6001 adds the power consumption amount calculated in the step S102 to the integral power consumption stored in the NVRAM 6004. Then, the CPU 6001 sends the integral power consumption calculated in the step S105 to the controller 20 via the communication interface 6003 (step S106). Further, the CPU 6001 clears the integral power consumption stored in the NVRAM 6004 to 0 (step S107), and proceeds to a step S110.

In the step S108, the CPU 6001 sends the power consumption amount calculated in the step S102 to the controller 20 via the communication interface 6003, and proceeds to the step S110.

In the step S109, the CPU 6001 calculates the integral power consumption by cumulatively calculating the power consumption amount calculated in the step S102, and stores the calculated integral power consumption in the NVRAM 6004, and proceeds to the step S110.

In the step S110, the CPU 6001 resets the timer 6005, and returns to the step S101.

FIG. 6 is a flowchart of a power consumption measurement result-receiving process executed by the controller 20. The present process is executed by the CPU 2001 of the controller 20.

The CPU 2001 determines whether or not the data of the power consumption amount or the integral power consumption has been received from the power measurement section 60 (step S201). If it is determined in the step S201 that the data of the power consumption amount or the integral power consumption has been received from the power measurement section 60, the CPU 2001 acquires the time from the RTC 2014 (step S202).

Next, the CPU 2001 stores the time acquired from the RTC 2014 and the power consumption amount or the integral power consumption received from the power measurement section 60 in the HDD 2009 (step S203), followed by terminating the present process.

FIG. 7 is a diagram showing an example of a power consumption display screen displayed on the console section 50 by the CPU 2001 based on the power consumption amount (including the integral power consumption) received by the controller 20.

The CPU 2001 can display the screen of the illustrated example in FIG. 7 on the console section 50 based on the time information and the data of the power consumption amount (including the integral power consumption), stored in the HDD 2009, in response to an instruction given by a user. In the case of the illustrated example, the screen is displayed so as to enable the user to grasp a relationship between the time zone and the power consumption amount. Further, the total power consumption amount for one day and the total power consumption amount for the immediately preceding day are displayed. Note that although the screen display shown in FIG. 7 displays the total power consumption amount per day, the contents to be displayed can be changed by settings.

FIG. 8 is a flowchart of an operation mode-shifting process executed when the image forming apparatus 100 according to the first embodiment shifts to the power saving state and when the image forming apparatus 100 returns from the power saving state.

The CPU 2001 determines whether or not the image forming apparatus 100 can be shifted to the power saving state (step S301). More specifically, the CPU 2001 determines whether or not the time elapsed after the image forming apparatus 100 executed e.g. a print job last time is equal to or longer than a predetermined time period. If it is determined that the image forming apparatus 100 can be shifted to the power saving state, the CPU 2001 disables the power measurement section interface 2013 (step S302). As a consequence, communication with the power measurement section 60 is lost, and hence the CPU 6001 shifts to a state unable to send data of the power consumption amount to the controller 20 which manages the power consumption amount.

Next, the CPU 2001 acquires the time at which the image forming apparatus 100 was shifted to the power saving state from the RTC 2014, and stores the acquired time in the NVRAM 2008 (step S303). Then, the CPU 2001 instructs the power supply controller 2012 to stop power supply from the power supply system C 1003 (step S304). As a consequence, the power supply controller 2012 stops power supply from the power supply system C 1003, and the image forming apparatus 100 is shifted to the power saving state. In the power saving state, electric power is supplied by the power supply system A 1001, and the communication controller 2010 determines whether or the image forming apparatus 100 is required to return from the power saving state to the normal state (step S305).

If it is determined that the image forming apparatus 100 is required to return from the power saving state e.g. due to receipt of print data from an external network, the communication controller 2010 instructs the power supply controller 2012 to return the image forming apparatus 100 from the power saving state (step S306). In the step S306, the power supply controller 2012 resumes power supply from the power supply system C 1003 which has been stopped.

Next, the CPU 2001 enables the power measurement section interface 2013 to resume communication with the power measurement section 60 (step S307), followed by terminating the present process.

As described above, according to the first embodiment, when it is determined that the operation mode of the image forming apparatus 100 is in the power saving mode, the power measurement section 60 cumulatively calculates and stores the power consumption amount without sending the calculated power consumption amount to the controller 20. This makes it possible to accurately measure the power consumption amount during the power saving state.

Next, a second embodiment of the present invention will be described. In the second embodiment, the image forming apparatus has the same configuration as that of the image forming apparatus according to the first embodiment described hereinabove with reference to FIGS. 1 to 4. Therefore, the same component elements as those of the first embodiment are denoted by the same reference numerals, and description thereof is omitted. The following description will be given mainly of different points from the first embodiment.

Although in the first embodiment, when the image forming apparatus 100 is in the normal state, the power consumption amount is periodically sent from the power measurement section 60 to the controller 20, in the present embodiment, an average value obtained by averaging values of the power consumption amount calculated several times is sent to the controller 20.

FIGS. 9A and 9B are a flowchart of a power consumption measurement process executed by the power measurement section 60 according to the second embodiment. The present process is executed by the CPU 6001 of the power measurement section 60.

The power measurement section 60 is configured to periodically send a calculated power consumption amount to the controller 20 as described above. To this end, the CPU 6001 determines whether or not a predetermined time period has elapsed (step S1101). The timer 6005 is used for determining whether or not the predetermined time period has elapsed. If it is determined that the predetermined time period has elapsed, the CPU 6001 calculates a power consumption amount (step S1102). More specifically, the CPU 6001 calculates a power consumption amount P using the following equation based on a value of current and a value of voltage detected by the current detecting section 6007 and the voltage detecting section 6008:

P=V*I*cos Θ*t

wherein V: value of voltage, I: value of current, Θ: power factor, t: predetermined time period (fixed time)

Next, the CPU 6001 determines whether or not the image forming apparatus 100 is in the power saving state (power saving mode) (step S1103). More specifically, the CPU 6001 communicates with the controller 20 via the communication interface 6003, and if a response is received from the controller 20, it is determined that the image forming apparatus 100 is in the normal state, whereas if not, it is determined that image forming apparatus 100 is in the power saving state. If it is determined in the step S1103 that the image forming apparatus 100 is not in the power saving state, the CPU 6001 proceeds to a step S1104, whereas if it is determined that the image forming apparatus 100 is in the power saving state, the CPU 6001 proceeds to a step S1110 in FIG. 9B.

In the step S1104, the CPU 6001 determines whether or not an integral power consumption has been stored in the NVRAM 6004. If it is determined in the step S1104 that the integral power consumption has been stored, the CPU 6001 proceeds to a step S1105, whereas if not, the CPU 6001 proceeds to a step S1109.

In the step S1105, the CPU 6001 adds the power consumption amount calculated in the step S1102 to the integral power consumption stored in the NVRAM 6004. Then, the CPU 6001 sends the integral power consumption calculated in the step S1105 to the controller 20 via the communication interface 6003 (step S1106). Further, the CPU 6001 clears the integral power consumption stored in the NVRAM 6004 to 0 (step S1107).

Next, the CPU 6001 clears a power saving state-power consumption amount measurement count stored in the RAM 6002 to 0 (step S1108), and proceeds to a step S1123. Here, the power saving state-power consumption amount measurement count is the number of times of measuring the power consumption amount during the power saving state, based on which the integral power consumption was cumulatively calculated in the power saving state.

In the step S1109, the CPU 6001 sends the power consumption amount calculated in the step S1102 to the controller 20 via the communication interface 6003, and proceeds to the step S1123.

In the step S1110 in FIG. 9B to which the CPU 6001 proceeds in a case where it is determined in the step S1103 that the image forming apparatus 100 is in the power saving state, the CPU 6001 stores the power consumption amount calculated in the step S1102 in the NVRAM 6004. Note that if the integral power consumption has been stored in the NVRAM 6004, the CPU 6001 adds the power consumption amount to the integral power consumption to thereby update the integral power consumption.

Next, the CPU 6001 determines whether or not the power saving state-power consumption amount measurement count stored in the RAM 6002 is equal to a predetermined number (step S1111). If it is determined the power saving state-power consumption amount measurement count is not equal to the predetermined number, the CPU 6001 proceeds to a step S1112, whereas if it is determined the power saving state-power consumption amount measurement count is equal to the predetermined number, the CPU 6001 proceeds to a step S1115.

In the step S1112, the CPU 6001 determines whether or not the power saving state-power consumption amount measurement count stored in the RAM 6002 exceeds the predetermined number. If it is determined the power saving state-power consumption amount measurement count exceeds the predetermined number, the CPU 6001 proceeds to a step S1114, whereas if it is determined the power saving state-power consumption amount measurement count does not exceed the predetermined number, the CPU 6001 proceeds to a step S1113.

In the step S1113, the CPU 6001 increments the power saving state-power consumption amount measurement count stored in the RAM 6002, by one, and then proceeds to the step S1114. In the step S1114, the CPU 6001 stores the power consumption amount measured in the step S1102 in the NVRAM 6004, and then proceeds to the step S1123 in FIG. 9A.

On the other hand, in the step S1115, the CPU 6001 calculates an average value (average power consumption amount) by dividing the integral power consumption stored in the NVRAM 6004 by the predetermined number of the power saving state-power consumption amount measurement count. Then, the CPU 6001 calculates a difference between the average power consumption amount calculated in the step S1115 and the power consumption amount calculated this time in the step S1102 (step S1116).

Next, the CPU 6001 determines whether or not the difference between the average power consumption amount and the power consumption amount calculated this time, which is calculated in the step S1116, is not larger than a predetermined value (step S1117). If it is determined that the difference between the average power consumption amount and the power consumption amount calculated this time exceeds the predetermined value, the CPU 600 proceeds to the step S1113. On the other hand, if it is determined that the difference between the average power consumption amount and the power consumption amount calculated this time is not larger than the predetermined value, the CPU 6001 stops the timer 6005 in the power measurement section 60 (step S1118), and clears the integral power consumption stored in the NVRAM 6004 in the step S1110 to 0 (step S1119).

Next, the CPU 6001 stores the average power consumption amount calculated in the step S1115 in a predetermined area of the NVRAM 6004 (step S1120).

Next, the CPU 6001 clears the power saving state-power consumption amount measurement count, stored in the RAM 6002, to 0 (step S1121), and sends an instruction to the power supply controller 2012 for switching off the power measurement section 60 (step S1122), followed by terminating the present process.

In the step S1123 in FIG. 9A, the CPU 6001 resets the timer 6005, and returns to the step S1101.

FIG. 10 is a flowchart of an operation mode-shifting process executed when the image forming apparatus 100 according to the second embodiment shifts to the power saving state and when the image forming apparatus 100 returns from the power saving state.

The CPU 2001 determines whether or not the image forming apparatus 100 can be shifted to the power saving state (step S1201). More specifically, the CPU 2001 determines whether or not the time elapsed after the image forming apparatus 100 executed e.g. a print job last time is equal to or longer than a predetermined time period. If it is determined that the image forming apparatus 100 can be shifted to the power saving state, the CPU 2001 disables the power measurement section interface 2013 (step S1202). As a consequence, communication with the power measurement section 60 is lost, and hence the CPU 6001 shifts to a state unable to send data of the power consumption amount to the controller 20.

Next, the CPU 2001 acquires the time at which the image forming apparatus 100 was shifted to the power saving state from the RTC 2014, and stores the acquired time in the NVRAM 2008 (step S1203). Then, the CPU 2001 instructs the power supply controller 2012 to stop power supply from the power supply system C 1003 (step S1204). As a consequence, the power supply controller 2012 stops power supply from the power supply system C 1003, and the image forming apparatus 100 is shifted to the power saving state. In the power saving state, electric power is supplied by the power supply system A 1001, and the communication controller 2010 determines whether or not the image forming apparatus 100 is required to return from the power saving state to the normal state (step S1205).

If it is determined that the image forming apparatus 100 is required to return from the power saving state e.g. due to receipt of print data from an external network, the communication controller 2010 instructs the power supply controller 2012 to return the image forming apparatus 100 from the power saving state (step S1206). In the step S1206, the power supply controller 2012 causes power supply from the power supply system C 1003 which has been stopped to be resumed.

Next, the CPU 2001 enables the power measurement section interface 2013 to resume communication with the power measurement section 60 (step S1207).

Next, the CPU 2001 sends an average power consumption amount acquisition request to the power measurement section 60 for acquiring an average power consumption amount via the power measurement section interface 2013 (step S1208). The average power consumption amount is the one calculated in the step S1115 in FIG. 9B.

Next, the CPU 2001 determines whether or not the average power consumption amount has been acquired in a step S1209, and if the average power consumption amount has been acquired, the CPU 2001 proceeds to a step S1210, whereas if not, the present process is terminated.

In the step S1210, the CPU 2001 acquires the current time from the RTC 2014, and calculates a time period which elapsed in the power saving state based on the time at which the image forming apparatus 100 was shifted to the power saving state, stored in the step S1203, and the acquired current time. Then, the CPU 2001 calculates the power consumption amount during the power saving state based on the time which elapsed in the power saving state and the average power consumption amount acquired in the step S1208, and stores the calculated power consumption amount in the HDD 2009 with the current time acquired from the RTC 2014.

FIG. 11 is a flowchart of a process executed by the power measurement section 60 for responding to the average power consumption amount acquisition request received from the controller 20 in the step S1208 in FIG. 10.

The CPU 6001 determines whether or not the average power consumption amount acquisition request has been received from the controller 20 via the communication interface 6003 (step S1301). If the average power consumption amount acquisition request has been received, the CPU 6001 determines whether or not the average power consumption amount has been stored in the NVRAM 6004 in the power measurement section 60 (step S1302). If it is determined that the average power consumption amount has not been stored, the CPU 6001 notifies the controller 20 via the communication interface 6003 that the average power consumption amount has not been stored (step S1303), followed by terminating the present process.

On the other hand, if it is determined in the step S1302 that the average power consumption amount has been stored in the NVRAM 6004, the CPU 6001 notifies the controller 20 of the average power consumption amount via the communication interface 6003 (step S1304). Then, the CPU 6001 clears the average power consumption amount stored in the NVRAM 6004 (step S1305), followed by terminating the present process. Note that the average power consumption amount stored in the NVRAM 6004 is the one stored in the step S1120 in FIG. 9B.

As described above, according to the second embodiment, the power measurement section 60 divides the integral power consumption obtained by cumulative calculation of values of the power consumption amount measured several times, by the predetermined number of the power saving state-power consumption amount measurement count, to thereby calculate the average value (average power consumption amount), and compares the difference between the calculated average power consumption amount and the power consumption amount measured this time with the predetermined value. Then, if the difference between the calculated average power consumption amount and the current power consumption amount is not larger than the predetermined value, the calculated average power consumption amount is stored, and the supply of electric power to the power measurement section 60 is stopped. As a consequence, under such a condition that the power consumption in the power saving state is stable, it is possible to accurately calculate the power consumption amount while move effectively reducing the power consumption amount during the power saving state than in the first embodiment.

Although in the first and second embodiments, the description has been given of the image forming apparatus as an example of an electronic apparatus, the present invention can also be applied to an electronic apparatus other than the image forming apparatus insofar as it is an electronic apparatus equipped with a function of realizing power saving by switching the operation mode between the normal mode and the power saving mode.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-049237, filed Mar. 12, 2013, which is hereby incorporated by reference herein in its entirety.

1. An electronic apparatus equipped with a power saving function for switching an operation mode between a normal state and a power saving state, comprising:
a measurement unit configured to measure a power of the electronic apparatus; and
a management unit configured to manage the power of the electronic apparatus based on the power measured by said measurement unit,
wherein when it is determined that the operation mode is the power saving state, said measurement unit stores the measured power without sending the measured power to said management unit.

2. The electronic apparatus according to claim 1, wherein said measurement unit cumulatively calculates and stores the power which is measured periodically.

3. The electronic apparatus according to claim 1, wherein when the operation mode is the power saving state, supply of electric power to said management unit is stopped.

4. The electronic apparatus according to claim 1, further comprising a display unit configured to display the power managed by said management unit.

5. The electronic apparatus according to claim 1, wherein said measurement unit includes:
a calculation unit configured to calculate an average value of the power based on values of the power which were calculated several times;
a comparison unit configured to compare a difference between the calculated average value of the power and a value of the power calculated this time with a predetermined value;
a control unit configured to store, when the difference between the calculated average value of the power and the value of the power calculated this time is not larger than the predetermined value, the calculated average value of the power, and stop supply of electric power to said measurement unit.

6. The electronic apparatus according to claim 1, wherein the power is a value of voltage, or a value of current, or a power consumption amount.

7. A method of controlling an electronic apparatus equipped with a power saving function for switching an operation mode between a normal state and a power saving state, comprising:
measuring a power of the electronic apparatus;
managing the power of the electronic apparatus based on the power measured by said measuring; and
storing, when it is determined that the operation mode is the power saving state, the measured power without sending the measured power.

8. A non-transitory computer-readable storage medium storing a computer-executable program for executing a method of controlling an electronic apparatus equipped with a power saving function for switching an operation mode between a normal state and a power saving state,
wherein the method comprises:
measuring a power of the electronic apparatus;
managing the power of the electronic apparatus based on the power measured by said measuring; and
storing, when it is determined that the operation mode is the power saving state, the measured power without sending the measured power.
